(19) United States
(12) Patent Application Publication
(10) Pub. No.: US 2013/0203406 A1
(43) Pub. Date: Aug. 8, 2013

(54) METHOD OF CONTROLLING MINIMIZATION OF DRIVE TESTS

(71) Applicant: ACER INCORPORATED, New Taipei City (TW)

(72) Inventor: Ming-Dao Chuang, New Taipei City (TW)

(73) Assignee: ACER INCORPORATED, New Taipei City (TW)

(21) Appl. No.: 13/757,838

(22) Filed: Feb. 3, 2013

Related U.S. Application Data
(60) Provisional application No. 61/595,157, filed on Feb. 6, 2012.

(30) Foreign Application Priority Data
Mar. 23, 2012 (TW) 101110125

(51) Int. Cl. H04W 24/02

(52) U.S. Cl. CPC H04W 24/02
USPC 455/424

(57) ABSTRACT

A user equipment is configured to operate in an idle mode according to an MDT configuration. When receiving a stop signal from a base station, the user equipment is configured to switch off one or multiple ongoing logged MDTs in the idle mode according to the stop signal.

### CROSS REFERENCE TO RELATED APPLICATIONS

This application claims priority of U.S. Patent Application No. 61/595,157 filed on 2012 Feb. 6, which is included in its entirety herein by reference.

### BACKGROUND OF THE INVENTION

1. Field of the Invention

The present invention is related to a method of controlling minimization of drive test, and more particularly, to a method of switching off minimization of drive test in the idle mode.

2. Description of the Prior Art

The 3rd Generation Partnership Project (3GPP) has developed a universal mobile telecommunications system (UMTS) which adopts a wideband code division multiple access (WCDMA) technology capable of providing high frequency spectrum utilization, universal coverage, and high-speed/quality multimedia data transmission. In the UMTS, a radio access network known as a universal terrestrial radio access network (UTRAN) includes multiple base stations, commonly known as Node-Bs (NBs), for communicating with multiple user equipments (UEs). Furthermore, a long-term evolution (LTE) system is now being developed by the 3GPP in order to further improve performance of the UMTS to satisfy users' increasing needs. The LTE system includes a new radio interface and radio network architecture which provides a high data rate, low latency, packet optimization, and improved system capacity and coverage. In the LTE system, a radio access network known as an evolved UTRAN (E-UTRAN) includes multiple evolved NBs (eNBs) for communicating with multiple UEs and a core network which includes a mobility management entity (MME), a serving gateway and other devices for NAS (Non Access Stratum) control.

NBs of the wireless communication system must be deployed properly in order to provide seamless, high quality and large signal coverage without experiencing call drops or signal degradation. However, planning and optimizing the deployment of the NBs are based on signal quality measurements which may be time- and effort-consuming for an operator of the wireless communication system. Common methods of performing the measurements include measuring the signal strength or quality at different time and geographical locations of interest. Therefore, it is more economical for a UE of the wireless communication to perform the measurements and send the measurement report to a NB. Based on the measurement reports received from multiple UEs, the deployment of the NBs may be planned and optimized accordingly without spending many human and material resources. For such measurements, minimization of drive tests (MDTs) which include immediate MDT and logged MDT are defined in corresponding 3GPP specifications.

A UE is configured to perform an immediate MDT in a connected mode, in which reference signal received power (RSRP), reference signal received quality (RSRQ), power headroom (PH), uplink signal strength, or signal to interference and noise ratio (SINR) may be measured. The UE may report the measurement results to a NB serving the UE when a report condition is satisfied.

In order to perform a logged MDT, a UE is configured to receive a logged measurement configuration message from the NB in the connected mode. The logged measurement configuration message is associated with an MDT configuration which includes measurement duration, measurement interval or measurement parameter. After entering an idle mode, the UE is configured to perform a logged MDT according to the logged measurement configuration message and store the measurement result. When the measurement length or the amount of the measurement data exceed a predetermined value, the UE stops performing the logged MDT and sends the measurement result to the NB after switching to the connected mode.

In the prior art when a UE is performing a logged MDT in the idle mode, if the NB requests the ongoing logged MDT to be switched off for some reason, the UE needs to switch to the connected mode for receiving the corresponding instruction from the network. In other words, the NB is unable to directly control the operation of the UE in the idle mode. The UE is constantly required to switch between the connected mode and the idled mode, which may consume more power and waste network resources.

### SUMMARY OF THE INVENTION

The present invention provides a method of controlling minimization of drive test. The method includes a user equipment performing one or multiple logged MDTs in an idle mode, and the user equipment switching off one or more multiple ongoing specific logged MDTs in the idle mode according to a stop signal received from a base station.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-3 are flowcharts illustrating methods of switching off logged MDT in the idle mode according to embodiments of the present invention.

### DETAILED DESCRIPTION

For a UE and a base station in a wireless communication system, the present invention provides a method of controlling a logged MDT in the idle mode. The UE may switch off the logged MDT directly according to messages received from the base station without switching to the connected mode. In the present invention, the wireless communication system may be a UMTS or an LTE system which includes a network and multiple UEs in a simplified embodiment. In the UMTS, the network may be a UTRAN including a plurality of NBs. In the LTE system, the network may be an E-UTRAN including a plurality of eNBs. The UE may be a mobile phone, a laptop computer, a tablet computer, an e-book or any portable computer system. However, the above examples are merely embodiments and do not limit the scope of the present invention.

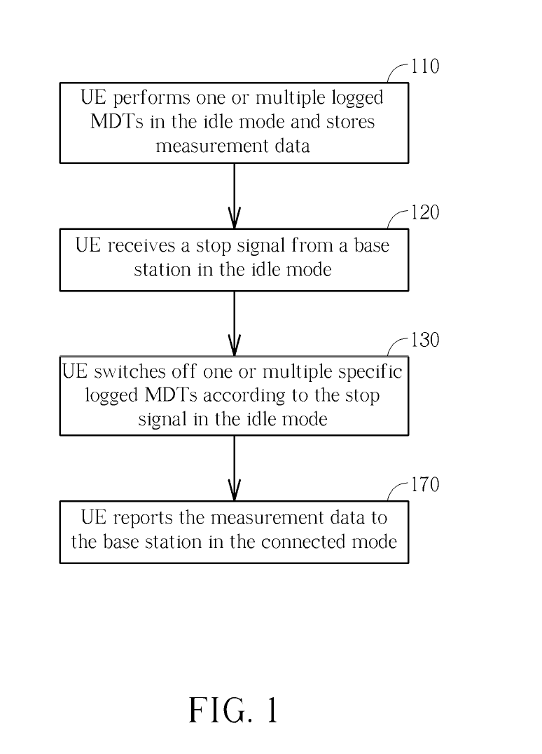

FIG. 1 is a flowchart illustrating a method of switching off logged MDT in the idle mode according to a first embodiment of the present invention. The flowchart in FIG. 1 includes the following steps:

Step 110: UE performs one or multiple logged MDTs in the idle mode and stores measurement data.

Step 120: UE receives a stop signal from a base station in the idle mode.

Step 130: UE switches off one or multiple specific logged MDTs according to the stop signal in the idle mode.

Step 170: UE reports the measurement data to the base station in the connected mode.

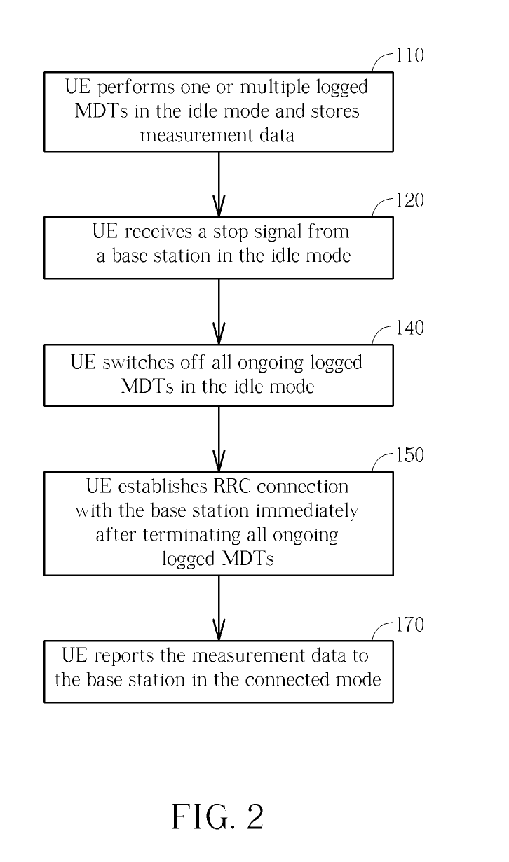

FIG. 2 is a flowchart illustrating a method of switching off logged MDT in the idle mode according to a second embodiment of the present invention. The flowchart in FIG. 2 includes the following steps:

Step 110: UE performs one or multiple logged MDTs in the idle mode and stores measurement data.

Step 120: UE receives a stop signal from a base station in the idle mode.

Step 140: UE switches off all ongoing logged MDTs in the idle mode.

Step 150: UE establishes a radio resource control (RRC) connection with the base station immediately after terminating all ongoing logged MDTs.

Step 170: UE reports the measurement data to the base station in the connected mode.

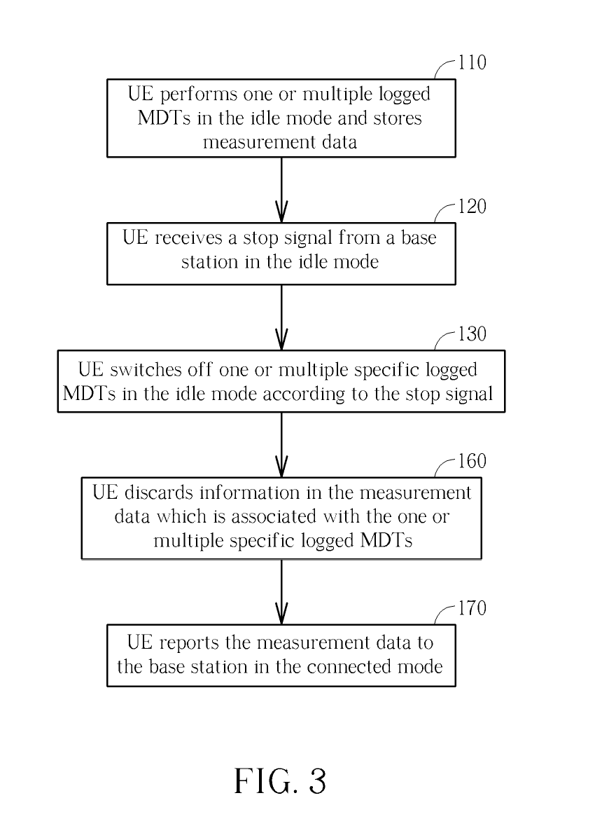

FIG. 3 is a flowchart illustrating a method of switching off logged MDT in the idle mode according to a third embodiment of the present invention. The flowchart in FIG. 3 includes the following steps:

Step 110: UE performs one or multiple logged MDTs in the idle mode and stores measurement data.

Step 120: UE receives a stop signal from a base station in the idle mode.

Step 130: UE switches off one or multiple specific logged MDTs in the idle mode according to the stop signal.

Step 160: UE discards information in the measurement data which is associated with the one or multiple specific logged MDTs.

Step 170: UE reports the measurement data to the base station in the connected mode.

When the UE is the connected mode before executing step 110, the base station may send a logged measurement configuration message which is associated with a specific MDT configuration. In step 110, the UE may operate in the idle mode according to the logged measurement configuration message, such as performing one or multiple logged MDTs.

In step 120, the base station may send the stop signal to the UE if the network has requested the UE to switch off one or multiple ongoing logged MDT for some reason, such as after having collected sufficient user information, after achieving network optimization, or for power-saving purpose.

According to corresponding 3GPP specifications (such as Rel-10 TS 37.320), the base station may send a paging message via a paging control channel (PCCH) to the UE when operating in the idle mode. The paging message may include information such as CN domain indicator, UE identification, paging range and paging cause. In the embodiment of the present invention, the stop signal maybe an over-the-air (OTA) paging message with a paging cause “switch off logged MDT” which may indicate the termination of one or multiple specific logged MDTs.

According to corresponding 3GPP specifications (such as Rel-10 TS 37.320), the base station may send a logged measurement configuration message to the UE when operating in the connected mode. The logged measurement configuration message may include MDT configuration such as measurement duration, measurement interval or measurement parameter. In the embodiment of the present invention, the stop signal maybe an OTA logged measurement configuration message with a specific parameter set to be associated with the termination of one or multiple specific logged MDTs.

In the first embodiment of the present invention, the UE is configured to switch off one or multiple ongoing specific logged MDTs in the idle mode according to the stop signal in step 130 after receiving the stop signal from the base station. After completing other logged MDTs, the UE may switch to the connected mode and report the measurement data to the base station in step 170. In this embodiment, the reported measurement data includes information associated with the one or more specific logged MDTs collected before receiving the stop signal.

In the second embodiment of the present invention, the UE is configured to switch off all ongoing logged MDTs in the idle mode according to the stop signal in step 140 after receiving the stop signal from the base station. Next, the UE is configured to switch to the connected mode by establishing a radio resource control (RRC) connection with the base station in step 150 immediately after terminating all ongoing logged MDTs. After entering the connected mode, the UE is configured to report the measurement data to the base station in step 170. In this embodiment, the reported measurement data includes information associated with the one or more specific logged MDTs collected before receiving the stop signal.

In the third embodiment of the present invention, the UE is configured to switch off one or multiple ongoing specific logged MDTs in the idle mode according to the stop signal in step 130. The UE is then configured to discard information in the measurement data which is associated with the one or multiple specific logged MDTs in step 160 and report the measurement data to the base station in step 170. In this embodiment, the reported measurement data does not include information associated with the one or more specific logged MDTs collected before receiving the stop signal.

In the present invention, the UE may switch off one, multiple or all ongoing specific logged MDTs in the idle mode according to the stop signal received from the base station. The information associated with the one or more specific logged MDTs collected before receiving the stop signal may be reported to the base station when the UE enters the connected mode, or may be discarded directly. Since the UE may switch off one or multiple ongoing specific logged MDTs in the idle mode without switching to the connected mode, the present invention is advantageous in lowering power consumption and economizing network resources.

Those skilled in the art will readily observe that numerous modifications and alterations of the device and method may be made while retaining the teachings of the invention. Accordingly, the above disclosure should be construed as limited only by the metes and bounds of the appended claims.

what is claimed is:

1. A method of controlling minimization of drive test (MDT), comprising:
a user equipment performing one or multiple logged MDTs in an idle mode; and
the user equipment switching off one or more multiple ongoing specific logged MDTs in the idle mode according to a stop signal received from a base station.

2. The method of claim 1, further comprising:
the user equipment switching to a connected mode for reporting measurement data associated with the one or multiple logged MDTs to the base station.

3. The method of claim 2, further comprising:
the user equipment switching off all ongoing logged MDTs in the idle mode according to the stop signal and then immediately switching to the connected mode by establishing a radio resource control (RRC) connection with the base station.

4. The method of claim 1, further comprising:
the user equipment discarding information in the measurement data which is associated with the one or multiple specific logged MDTs.

5. The method of claim 1, further comprising:
the user equipment receiving a logged measurement configuration message associated with an MDT configuration from the base station in a connected mode before entering the idle mode; and
the user equipment performing the one or multiple logged MDTs according to the logged measurement configuration message.

6. The method of claim 1, wherein the stop signal is a paging message received from the base station via a paging control channel (PCCH) and a paging cause of the paging message is associated with terminating the one or multiple specific logged MDTs.

7. The method of claim 1, wherein the stop signal is a logged measurement configuration message which includes settings for terminating the one or multiple specific logged MDTs.
